(19) United States
(12) Patent Application Publication
(10) Pub. No.: US 2026/0342612 A1
(43) Pub. Date: Oct. 29, 2026

(54) INNOVATIVE APPLICATION OF A GENERAL PURPOSE INPUT OUTPUT GATEWAY IN AUTOMOTIVE ELECTRONIC CONTROL UNIT DESIGN

(71) Applicants: FCA US LLC, Auburn Hills, MI (US); Stellantis Auto SAS, Poissy (FR)

(72) Inventors: Doug Yang, Auburn Hills, MI (US); Haikuan Qiu, Auburn Hills, MI (US)

(21) Appl. No.: 19/190,036

(22) Filed: Apr. 25, 2025

(51) Int. Cl. H04L 12/40; H04L 12/66

(52) U.S. Cl. CPC H04L 12/40097; H04L 12/66; H04L 2012/40215; H04L 2012/40273

(57) ABSTRACT

Control systems and methods for a vehicle include an electronic control unit (ECU), a plurality of peripheral systems connected to the ECU, wherein the ECU and the plurality of peripheral systems are configured to exchange a plurality of general purpose input output (GPIO) signals, and a GPIO gateway arranged between the ECU and the plurality of peripheral systems, the GPIO gateway being configured to configure, based on a firmware, a remapping of the plurality of GPIO signals, intercept the plurality of GPIO signals being exchanged between the ECU and the plurality of peripheral systems, remap the plurality of GPIO signals according to the remapping to obtain a remapped plurality of GPIO signals, and output, to at least one of the ECU and the plurality of peripheral systems, the remapped plurality of GPIO signals.

### FIELD

The present application generally relates to automotive electronic control units (ECUs) and, more particularly, to an innovative application of a general purpose input output (GPIO) gateway in automotive ECU design.

### BACKGROUND

Today's vehicles require different electronic control unit (ECU) and general purpose input output (GPIO) assignments for different trim levels of the same brand/model of an original equipment manufacturer (OEM) vehicle. The GPIO pins include peripheral systems (sub-controllers, actuators, sensors, etc.), which can vary depending on the ECUs and features implemented or active on a particular trim level of the vehicle. For example, higher trim levels may have more features than lower trim levels of a same vehicle brand/model. Due to these hardware differences between the OEM and suppliers (e.g., of peripheral systems), a hardware redesign can be required for each trim level of the vehicle. More specifically, the suppliers must redesign the board support package (BSP) and GPIO communication interface drivers. This process is costly and timely, potentially adding months to a vehicle development timeline. Accordingly, while such conventional ECU and GPIO systems do work for their intended purpose, there exists an opportunity for improvement in the relevant art.

### SUMMARY

According to one example aspect of the invention, a control system for a vehicle is presented. In one exemplary implementation, the control system comprises an electronic control unit (ECU), a plurality of peripheral systems connected to the ECU, wherein the ECU and the plurality of peripheral systems are configured to exchange a plurality of general purpose input output (GPIO) signals, and a GPIO gateway arranged between the ECU and the plurality of peripheral systems, the GPIO gateway being configured to configure, based on a firmware, a remapping of the plurality of GPIO signals, intercept the plurality of GPIO signals being exchanged between the ECU and the plurality of peripheral systems, remap the plurality of GPIO signals according to the remapping to obtain a remapped plurality of GPIO signals, and output, to at least one of the ECU and the plurality of peripheral systems, the remapped plurality of GPIO signals.

In some implementations, the GPIO gateway is a chiplet in addition to (i) a central processing unit (CPU) chiplet and (ii) a memory chiplet of a same chiplet die of a system-on-chip (SoC) that is shares a same printed circuit board (PCB) or motherboard with a GPIO interface integrated circuit (IC). In some implementations, the GPIO gateway is a separate monolithic IC in addition to (i) an SoC or system-in-package (SiP) monolithic IC and (ii) a GPIO interface monolithic IC on a same PCB or motherboard. In some implementations, the plurality of GPIO signals include (i) control signals for one or more actuators of the plurality of peripheral systems, (ii) general purpose circuit signals, and (iii) serial communication interface signals to/from at least one of a sensor and an actuator of the plurality of peripheral systems.

In some implementations, the control signals include enable/disable signals for each of the one or more actuators, wherein the general purpose circuit signals include at least one of chip-select (CS) signals, a general purpose clock signal, and boot configuration pull-up/pull-down signals, and wherein the serial communication interface signals include at least one of an actuator command and a sensor signal. In some implementations, the serial communication interface signals are transmitted via a set of serial communication interfaces including at least at least one of (i) an inter-integrated circuit (I2C) protocol, (ii) a serial peripheral interface (SPI) protocol, and (iii) a universal asynchronous receiver/transmitter (UART) protocol.

In some implementations, the remapping specified by the firmware causes the GPIO gateway to act as a switch matrix to convert the plurality of GPIO signals into the remapped plurality of GPIO signals. In some implementations, the firmware of the GPIO gateway is changed or updated for different trim levels of a same model of the vehicle, and wherein each of the different trim levels has different features. In some implementations, the GPIO gateway and its firmware allow a same ECU to be utilized for each of the different trim levels of the same model of the vehicle, and wherein the plurality of GPIO signals are associated with a plurality of physical GPIO pins of the ECU. In some implementations, the GPIO gateway and its firmware allow a same board support package (BSP) to be utilized by suppliers of the plurality of peripheral systems.

According to another example aspect of the invention, a control method for a vehicle is presented. In one exemplary implementation, the control method comprises providing an ECU, providing a plurality of peripheral systems connected to the ECU, wherein the ECU and the plurality of peripheral systems are configured to exchange a plurality of GPIO signals, providing a GPIO gateway arranged between the ECU and the plurality of peripheral systems, configuring, by the GPIO gateway and based on a firmware, a remapping of the plurality of GPIO signals, intercepting, by the GPIO gateway, the plurality of GPIO signals being exchanged between the ECU and the plurality of peripheral systems, remapping, by the GPIO gateway, the plurality of GPIO signals according to the remapping to obtain a remapped plurality of GPIO signals, and outputting, by the GPIO gateway and to at least one of the ECU and the plurality of peripheral systems, the remapped plurality of GPIO signals.

In some implementations, the GPIO gateway is a chiplet in addition to (i) a CPU chiplet and (ii) a memory chiplet of a same chiplet die of an SoC that is shares a same PCB or motherboard with a GPIO interface IC. In some implementations, the GPIO gateway is a separate monolithic IC in addition to (i) an SoC or SiP monolithic IC and (ii) a GPIO interface monolithic IC on a same PCB or motherboard. In some implementations, the plurality of GPIO signals include (i) control signals for one or more actuators of the plurality of peripheral systems, (ii) general purpose circuit signals, and (iii) serial communication interface signals to/from at least one of a sensor and an actuator of the plurality of peripheral systems.

In some implementations, the control signals include enable/disable signals for each of the one or more actuators, wherein the general purpose circuit signals include at least one of CS signals, a general purpose clock signal, and boot configuration pull-up/pull-down signals, and wherein the serial communication interface signals include at least one of an actuator command and a sensor signal. In some implementations, the serial communication interface signals are transmitted via a set of serial communication interfaces including at least at least one of (i) I2C protocol, (ii) an SPI protocol, and (iii) a UART protocol.

In some implementations, the remapping specified by the firmware causes the GPIO gateway to act as a switch matrix to convert the plurality of GPIO signals into the remapped plurality of GPIO signals. In some implementations, the control method further comprises changing or updating, at the GPIO gateway, the firmware for different trim levels of a same model of the vehicle, wherein each of the different trim levels has different features. In some implementations, the GPIO gateway and its firmware allow a same ECU to be utilized for each of the different trim levels of the same model of the vehicle, and wherein the plurality of GPIO signals are associated with a plurality of physical GPIO pins of the ECU. In some implementations, the GPIO gateway and its firmware allow a same BSP to be utilized by suppliers of the plurality of peripheral systems.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having a control system with an example general purpose input output (GPIO) gateway according to the principles of the present application;

FIG. 2 is a functional block diagram of an example system architecture for the control system with the GPIO gateway according to the principles of the present application;

FIGS. 3A-3B are functional block diagrams of two example circuit board configurations for the GPIO gateway according to the principles of the present application; and

FIG. 4 is a flow diagram of an example method for implementing and utilizing a control system with a GPIO gateway in vehicle according to the principles of the present application.

### DESCRIPTION

As previously discussed, today's vehicle control systems often include a plurality of electronic control units (ECUs) each connected to various peripheral systems (actuators, sensors, etc.) via various communication interfaces. Different trim levels of the same brand/model vehicle of an original equipment manufacturer (OEM) can require different ECU and general purpose input output (GPIO) assignments depending on the ECUs and features implemented or active on a particular trim level of the vehicle. For example, higher trim levels may have more features than lower trim levels of a same vehicle brand/model (autonomous driving features, self-parking or parking assist features, etc.). Due to these hardware differences between the OEM and suppliers (e.g., of peripheral systems), a hardware redesign can be required for each trim level of the vehicle. More specifically, the suppliers must redesign the board support package (BSP) and GPIO communication interface drivers. This process is costly and timely, potentially adding months to a vehicle development timeline. Thus, an opportunity for improvement exists in the relevant art.

Accordingly, an innovative application of a GPIO gateway in automotive ECU design is presented herein. This GPIO gateway is a new separate circuit that can be implemented between ECUs and peripheral systems of a vehicle's control system. GPIOs from each ECU are routed to the GPIO gateway, which is programmed based on different trim levels to remap the GPIOs to control signals (e.g., enable/disable), general purpose circuit signals (clock, chip-select or CS, clock, boot configuration pull-up/pull-down, etc.), and serial communication protocols such as inter-integrated circuit (I2C), serial peripheral interface (SPI), and universal asynchronous receiver/transmitter (UART). In other words, the GPIO gateway will act as a switch matrix and, for each trim level of the vehicle, only a firmware update of the GPIO gateway will be required. The GPIO gateway could be implemented either (1) as a dedicated (monolithic) integrated circuit (IC) on a printed circuit board (PCB) or motherboard or (2) as a chiplet die component of a system-on-chip (SoC) of the PCB or motherboard. Potential benefits include reduced design/implementation costs and significant development time (e.g., months) saved for a particular vehicle having multiple trim levels.

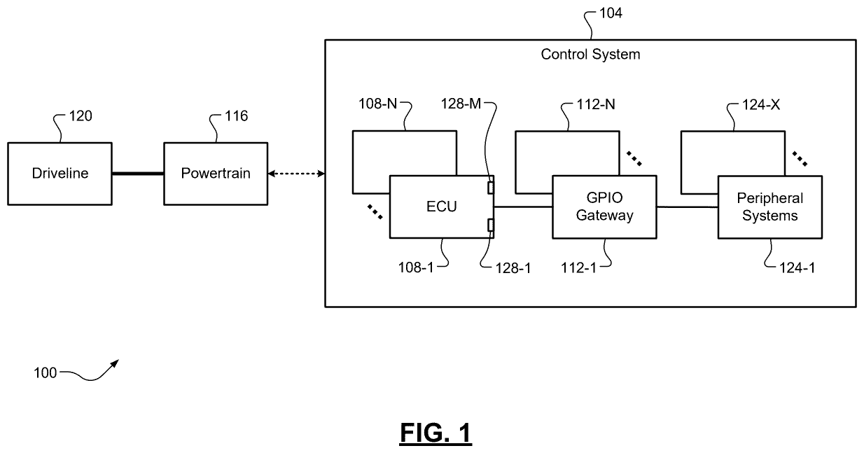

Referring now to FIG. 1, a functional block diagram of a vehicle 100 having a control system 104 with an ECU 108 and example GPIO gateway 112 according to the principles of the present application is illustrated. The vehicle 100 generally comprises a powertrain 116 configured to generate and transfer drive torque to a driveline 120 for propulsion. Non-limiting examples of components of the powertrain 116 include an internal combustion engine, an electric traction motor with a high voltage battery pack or system and an inverter, and a transmission, gearbox, or gear reducer. Non-limiting examples of components of the driveline 120 include a differential, axles or half-shafts, and wheels/hubs. The control system 104 is configured to control operation of the vehicle 100, which primarily involves controlling the powertrain 116 to generate a sufficient amount of drive torque to satisfy a torque request provided by a driver of the vehicle 100 via a driver interface (not shown), such as an accelerator pedal. The control system 104 includes a plurality of ECUs 108-1 . . . 108-N (N>1, collectively “ECUs 108”) connected to each other via a controller area network (CAN) or other suitable communication network (not shown).

Non-limiting examples of the ECUs 108 include a supervisory ECU, an engine ECU, a motor ECU, a battery ECU, a transmission ECU, a body ECU, and an autonomous/ADAS ECU. For purposes of the present application, however, a single ECU 108 (hereinafter, “ECU 108”) will be referenced to describe the example GPIO gateway 112 and its features and functionality. In that regard, each of the plurality of ECUs 108 could have its own GPIO gateway 112 and associated peripheral systems 124 (described below). In one exemplary embodiment, the ECU 108 is an edge-type ECU that acts as an edge or zone controller for a specific set of sub-systems of the vehicle 100, and the control system 104 could further include other supervisory or higher level ECUs 108. The term “GPIO” as used herein refers to a signal pin (e.g., a digital signal pin) on an integrated circuit (IC) or electronic circuit board that can be used as an input, an output, or both, and is controllable by software. GPIOs do not have a predefined purpose and can be unused by default and can be selectively defined for usage depending on the application. As shown, the GPIO gateway 112 is connected to a plurality of physical GPIO pins 128-1 . . . 128-M (M>1, collectively “GPIO pins 128” or “GPIOs 128”) corresponding to a plurality of GPIO signals.

The GPIO gateway 112 is configured to remap the plurality of GPIO signals to a remapped plurality of GPIO signals, which are output from the GPIO gateway 112 to the ECU 108 and/or the plurality of peripheral systems 124 associated with the ECU 108. As mentioned above, each ECU 108 and GPIO gateway 112 can have its own plurality of from a plurality of pluralities of peripheral systems 124-1 . . . 124-X (X>1, collectively, “pluralities of peripheral systems 124”) and hereinafter “peripheral systems 124.” This remapping by the GPIO gateway 112 is specified by a current software or firmware (e.g., a current firmware version) that the GPIO gateway 112 is configured to execute. The GPIO gateway 112 can periodically receive firmware updates, which can cause the GPIO gateway 112 to adjust or alter its remapping of the GPIO signals to the remapped GPIO signals. Non-limiting examples of the peripheral systems 124 include actuators and sensors associated with the ECU 108, some of which can be connected to the GPIO gateway 112 via specific serial communication interface. Non-limiting examples of the remapped GPIO signals include control signals (e.g., enable/disable), general purpose circuit signals (clock, chip-select or CS, boot configuration pull-up/pull-down, etc.), and other signals (e.g., actuator/sensor signals) communicated via the serial communication interfaces (I2C, SPI, UART, etc.). It will be appreciated that these are merely examples of signals and communication interfaces that could be utilized in automotive applications and that the GPIO gateway 112 could be applicable to other signals/interfaces.

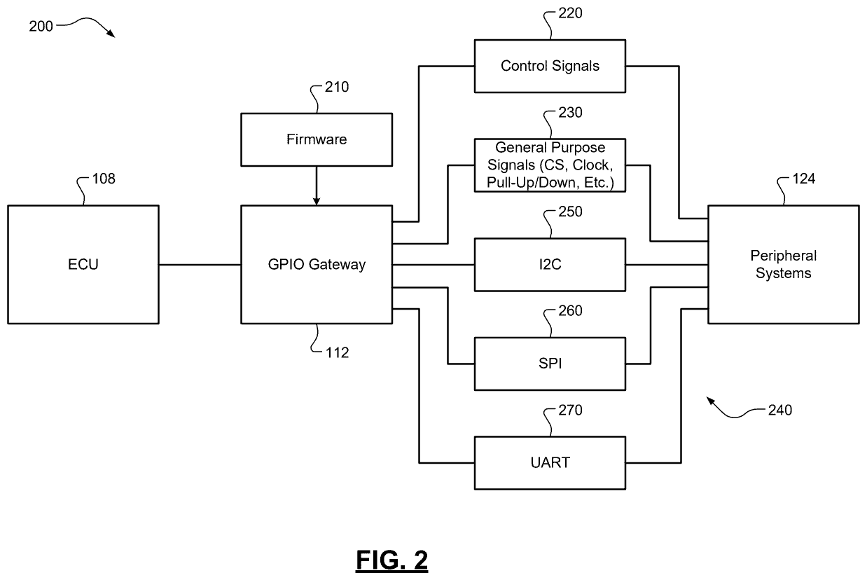

Referring now to FIG. 2 and with continued reference to FIG. 1, a functional block diagram of an example system architecture 200 for the control system 104 with the GPIO gateway 112 according to the principles of the present application is illustrated. As shown, the ECU 108 and the plurality of peripheral systems 124 are configured to exchange a plurality of GPIO signals, which could correspond to physical GPIO pins (not shown) of the ECU 108. These GPIO signals can include, but are not limited to, (i) control signals 220 (e.g., enable/disable signals for actuator(s) of the peripheral systems 124, (ii) general purpose circuit signals 230 (CS, clock, boot configuration pull-up/pull-down, etc.), and (iii) serial communication interface signals 240 (e.g., signals to/from actuator(s) and/or sensor(s) of the peripheral systems 124). These serial communication interface signals 240 can be communicated by at least one of a plurality of serial communication interfaces including, but not limited to, I2C 250, SPI 260, and UART 270. The GPIO gateway 112 is arranged between the ECU 108 and the peripheral systems 124 and acts as an intermediary or middle-man therebetween. More specifically, the GPIO gateway 112 acts as a switch matrix to convert the received GPIO signals to remapped GPIO signals that are finally output to the ECU 108 and/or to the peripheral systems 124. This remapping can be specified by a firmware 210 received and executed by the GPIO gateway 112, and there could be a different firmware 210 (e.g., a different version) provided for each of a plurality of different trim levels of the vehicle 100 (e.g., different trim levels with different features for a same model of the vehicle 100).

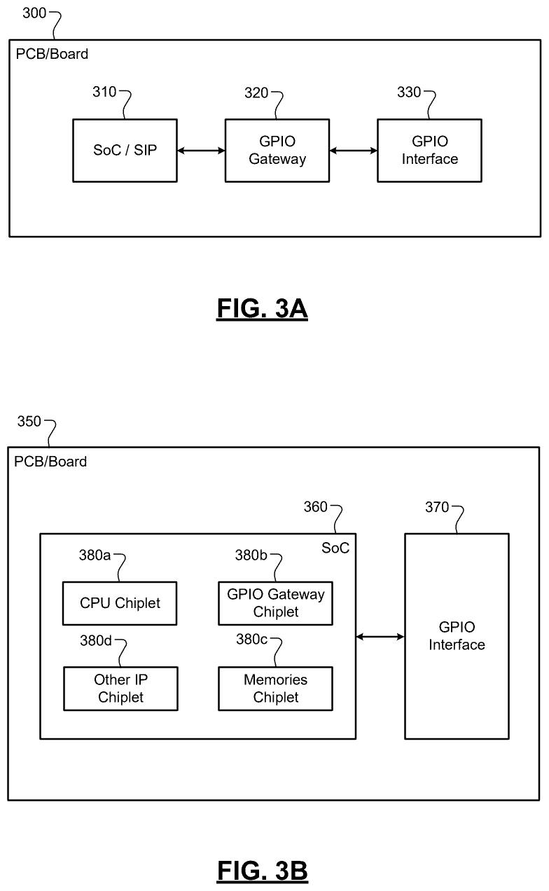

Referring now to FIGS. 3A-3B and with continued reference to the previous figures, functional block diagrams of two example circuit board configurations 300, 350 for the GPIO gateway 112 according to the principles of the present application are illustrated. In the first example embodiment illustrated in FIG. 3A, the GPIO gateway 112 is a separate or dedicated (monolithic) IC 320 in addition to (i) a SoC or system-in-package (SiP) monolithic IC 310 and (ii) a GPIO interface monolithic IC 330 on a same PCB or motherboard 300. In contrast, in the second example embodiment illustrated in FIG. 3B, the GPIO gateway 112 is a chiplet 380b in addition to (i) a central processing unit (CPU) chiplet 380a and (ii) a memory chiplet 380c of a same chiplet die of an SoC 360 that is shares a same PCB or motherboard 350 with a GPIO interface IC 370. It will be appreciated that the SoC 350 could further include one or more chiplets 380d for other intellectual property (IP) that could be reusable (e.g., by an original equipment manufacturer, or OEM, for multiple different trim levels of a same particular model of a particular vehicle). Both of these configurations 300, 350 enable the GPIO gateway 112 (and its customizable firmware 210) allow for a same ECU 108 to be utilized for each of the different trim levels (e.g., the plurality of GPIO signals could be associated with a plurality of physical GPIO pins 128 of the ECU 108). Both of these configurations 300, 350 also enable the GPIO gateway 112 (with its customizable firmware) allow a same BSP to be utilized by suppliers of the plurality of peripheral systems 124. The second configuration 350, with its reusable chiplet dies and SoC customizability, could be considered a superior option due to its flexibility and potential cost savings.

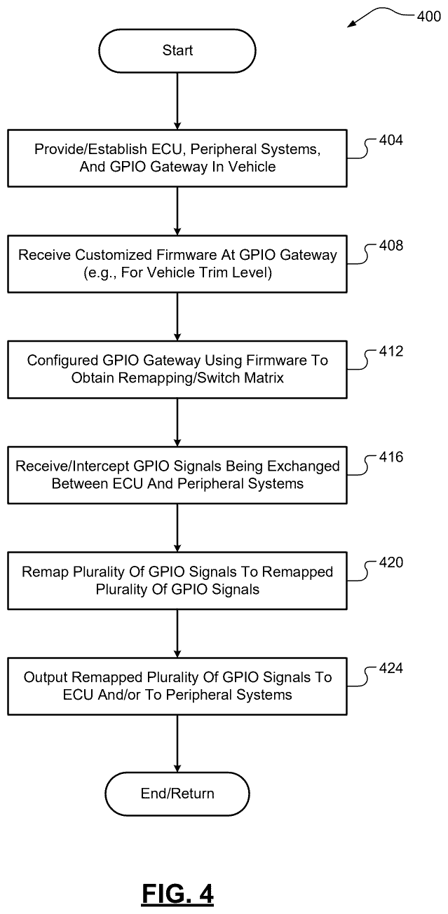

Referring now to FIG. 4 and with continued reference to the previous figures, a flow diagram of an example method 400 for implementing and utilizing a control system with a GPIO gateway in vehicle according to the principles of the present application is illustrated. While the method 400 specifically references the vehicle 100 and its components (e.g., control system 104 and GPIO gateway 112), it will be appreciated that the method 400 could be applicable to any suitably configured vehicle having a control system with a GPIO gateway implemented or implementable therein. The method 400 begins at 404 where the ECU 108, the peripheral systems 124, and the GPIO gateway 112 are provided or established. At 408, the GPIO gateway 112 receives the customized firmware 210, which can specify remapping for the plurality of GPIO signals, such as for a particular trim level of a particular OEM model of the vehicle 100. At 412, the GPIO gateway 112 configures itself (i.e., its remapping or switch matrix) based on the customized firmware. At 416, the GPIO gateway 112 receives or intercepts the plurality of GPIO signals being exchanged between the ECU 108 and the peripheral systems 124 (or vice-versa). At 420, the GPIO gateway 112 remaps the plurality of GPIO signals based on the configured remapping or switch matrix to obtain a remapped plurality of GPIO signals. At 424, the GPIO gateway 112 outputs the remapped plurality of GPIO signals to the ECU 108 and/or the peripheral systems 124 (i.e., wherever the original GPIO signals were headed upon interception at the GPIO gateway 112). The method 400 then ends or returns to 404. Firmware updates could be performed at vehicle assembly as well as during a lifetime of the vehicle 100 (e.g., during service or via a vehicle update). Upon receipt of a firmware update, the GPIO gateway 112 can update its remapping or switch matrix such that the plurality of GPIO signals are remapped or converted to the remapped plurality of GPIO signals as desired.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control system for a vehicle, the control system comprising:
an electronic control unit (ECU);
a plurality of peripheral systems connected to the ECU, wherein the ECU and the plurality of peripheral systems are configured to exchange a plurality of general purpose input output (GPIO) signals; and
a GPIO gateway arranged between the ECU and the plurality of peripheral systems, the GPIO gateway being configured to:
configure, based on a firmware, a remapping of the plurality of GPIO signals;
intercept the plurality of GPIO signals being exchanged between the ECU and the plurality of peripheral systems;
remap the plurality of GPIO signals according to the remapping to obtain a remapped plurality of GPIO signals; and
output, to at least one of the ECU and the plurality of peripheral systems, the remapped plurality of GPIO signals.

2. The control system of claim 1, wherein the GPIO gateway is a chiplet in addition to (i) a central processing unit (CPU) chiplet and (ii) a memory chiplet of a same chiplet die of a system-on-chip (SoC) that is shares a same printed circuit board (PCB) or motherboard with a GPIO interface integrated circuit (IC).

3. The control system of claim 1, wherein the GPIO gateway is a separate monolithic integrated circuit (IC) in addition to (i) a system-on-chip (SoC) or system-in-package (SiP) monolithic IC and (ii) a GPIO interface monolithic IC on a same printed circuit board (PCB) or motherboard.

4. The control system of claim 1, wherein the plurality of GPIO signals include (i) control signals for one or more actuators of the plurality of peripheral systems, (ii) general purpose circuit signals, and (iii) serial communication interface signals to/from at least one of a sensor and an actuator of the plurality of peripheral systems.

5. The control system of claim 4, wherein the control signals include enable/disable signals for each of the one or more actuators, wherein the general purpose circuit signals include at least one of chip-select (CS) signals, a general purpose clock signal, and boot configuration pull-up/pull-down signals, and wherein the serial communication interface signals include at least one of an actuator command and a sensor signal.

6. The control system of claim 5, wherein the serial communication interface signals are transmitted via a set of serial communication interfaces including at least at least one of (i) an inter-integrated circuit (I2C) protocol, (ii) a serial peripheral interface (SPI) protocol, and (iii) a universal asynchronous receiver/transmitter (UART) protocol.

7. The control system of claim 1, wherein the remapping specified by the firmware causes the GPIO gateway to act as a switch matrix to convert the plurality of GPIO signals into the remapped plurality of GPIO signals.

8. The control system of claim 1, wherein the firmware of the GPIO gateway is changed or updated for different trim levels of a same model of the vehicle, and wherein each of the different trim levels has different features.

9. The control system of claim 8, wherein the GPIO gateway and its firmware allow a same ECU to be utilized for each of the different trim levels of the same model of the vehicle, and wherein the plurality of GPIO signals are associated with a plurality of physical GPIO pins of the ECU.

10. The control system of claim 8, wherein the GPIO gateway and its firmware allow a same board support package (BSP) to be utilized by suppliers of the plurality of peripheral systems.

11. A control method for a vehicle, the control method comprising:
providing an electronic control unit (ECU);
providing a plurality of peripheral systems connected to the ECU, wherein the ECU and the plurality of peripheral systems are configured to exchange a plurality of general purpose input output (GPIO) signals;
providing a GPIO gateway arranged between the ECU and the plurality of peripheral systems;
configuring, by the GPIO gateway and based on a firmware, a remapping of the plurality of GPIO signals;
intercepting, by the GPIO gateway, the plurality of GPIO signals being exchanged between the ECU and the plurality of peripheral systems;
remapping, by the GPIO gateway, the plurality of GPIO signals according to the remapping to obtain a remapped plurality of GPIO signals; and
outputting, by the GPIO gateway and to at least one of the ECU and the plurality of peripheral systems, the remapped plurality of GPIO signals.

12. The control method of claim 11, wherein the GPIO gateway is a chiplet in addition to (i) a central processing unit (CPU) chiplet and (ii) a memory chiplet of a same chiplet die of a system-on-chip (SoC) that is shares a same printed circuit board (PCB) or motherboard with a GPIO interface integrated circuit (IC).

13. The control method of claim 11, wherein the GPIO gateway is a separate monolithic integrated circuit (IC) in addition to (i) a system-on-chip (SoC) or system-in-package (SiP) monolithic IC and (ii) a GPIO interface monolithic IC on a same printed circuit board (PCB) or motherboard.

14. The control method of claim 11, wherein the plurality of GPIO signals include (i) control signals for one or more actuators of the plurality of peripheral systems, (ii) general purpose circuit signals, and (iii) serial communication interface signals to/from at least one of a sensor and an actuator of the plurality of peripheral systems.

15. The control method of claim 14, wherein the control signals include enable/disable signals for each of the one or more actuators, wherein the general purpose circuit signals include at least one of chip-select (CS) signals, a general purpose clock signal, and boot configuration pull-up/pull-down signals, and wherein the serial communication interface signals include at least one of an actuator command and a sensor signal.

16. The control method of claim 15, wherein the serial communication interface signals are transmitted via a set of serial communication interfaces including at least at least one of (i) an inter-integrated circuit (I2C) protocol, (ii) a serial peripheral interface (SPI) protocol, and (iii) a universal asynchronous receiver/transmitter (UART) protocol.

17. The control method of claim 11, wherein the remapping specified by the firmware causes the GPIO gateway to act as a switch matrix to convert the plurality of GPIO signals into the remapped plurality of GPIO signals.

18. The control method of claim 11, further comprising changing or updating, at the GPIO gateway, the firmware for different trim levels of a same model of the vehicle, wherein each of the different trim levels has different features.

19. The control method of claim 18, wherein the GPIO gateway and its firmware allow a same ECU to be utilized for each of the different trim levels of the same model of the vehicle, and wherein the plurality of GPIO signals are associated with a plurality of physical GPIO pins of the ECU.

20. The control method of claim 18, wherein the GPIO gateway and its firmware allow a same board support package (BSP) to be utilized by suppliers of the plurality of peripheral systems.
